(19) United States
(12) Patent Application Publication
(10) Pub. No.: US 2025/0020516 A1
(43) Pub. Date: Jan. 16, 2025

(54) INFRARED DETECTOR BASED ON CMOS PROCESS

(71) Applicant: Beijing North Gaoye Technology Co., Ltd., Beijing (CN)

(72) Inventors: Guangjie ZHAI, Beijing (CN); Pei WU, Beijing (CN); Hui PAN, Beijing (CN); Guangqiang ZHAI, Beijing (CN)

(73) Assignee: Beijing North Gaoye Technology Co., Ltd., Beijing (CN)

(21) Appl. No.: 18/718,002

(22) PCT Filed: Mar. 24, 2022
(86) PCT No.: PCT/CN2022/082853

§ 371 Date: Jun. 7, 2024

(30) Foreign Application Priority Data
Mar. 26, 2021 (CN) 202110324010.0

(51) Int. Cl. G01J 5/20

(52) U.S. Cl. CPC G01J 5/20; G01J 2005/202

(57) ABSTRACT

An infrared detector based on a CMOS process is provided. A CMOS measuring circuit system (1) and a CMOS infrared sensing structure (2) in the infrared detector are both fabricated using the CMOS process, and the CMOS infrared sensing structure (2) is directly fabricated above the CMOS measuring circuit system (1); a CMOS fabricating process of the CMOS infrared sensing structure (2) comprises a metal interconnection process, an interconnect via process and an RDL process, the CMOS infrared sensing structure (2) comprises at least two metal interconnect layers, at least two dielectric layers and a plurality of interconnect through holes, the dielectric layer at least comprises one sacrificial layer and one thermal-sensitive dielectric layer, and the thermal-sensitive dielectric layer comprises a thermal-sensitive material with a temperature coefficient of resistance greater than a predetermined value; and the CMOS infrared sensing structure comprises a resonant cavity formed by a reflecting layer (4) and the thermal-sensitive dielectric layer, a suspended micro-bridge structure for controlling heat transfer and a columnar structure (6) having electrical connection and supporting functions. Problems of low performance, low pixel scale and low yield of a conventional infrared detector based on a MEMS process are solved, and the performance of the infrared detector is optimized.

### CROSS-REFERENCES TO RELATED APPLICATIONS

The disclosure claims the priority of Chinese Patent Application No. 202110324010.0, filed on Mar. 26, 2021, entitled “INFRARED DETECTOR BASED ON CMOS PROCESS,” the entire contents of which are incorporated herein by reference.

### TECHNICAL FIELD

The present disclosure relates to the technical field of infrared detection, in particular to an infrared detector based on a CMOS process.

### BACKGROUND

The monitoring market, automobile auxiliary market, household market, intelligent manufacturing market, mobile phone application and other fields all have a strong demand for uncooled high-performance chips, and have certain requirements for chip performances, performance consistency, and product prices. It is estimated that there are more than 100 million chips in potential demand every year, but the current process solution and architecture cannot meet the market demand.

At present, an infrared detector adopts the combination of a measuring circuit and an infrared sensing structure. The measuring circuit is fabricated by a Complementary Metal-Oxide-Semiconductor (CMOS) process, while the infrared sensing structure is fabricated by a Micro-Electro-Mechanical System (MEMS) process, which lead to the following problems:
(1) The infrared sensing structure is fabricated using the MEMS process, using polyimide as a sacrificial layer, which is not compatible with the CMOS process.
(2) Using the polyimide as the sacrificial layer has a problem that the release of polyimide is not complete, which affects the vacuum level of the detector chip, and also limits a subsequent thin film growth temperature, which is not conducive to the selection of materials.
(3) The polyimide may cause the height of a resonant cavity to be inconsistent, which makes it difficult to ensure a main operating wavelength.
(4) The control of the MEMS process is far worse than that of the CMOS process, which restricts the performance consistency and detection performance of the chip.
(5) The MEMS has low production capacity, low yield rate, and high costs, and cannot achieve large-scale mass production.
(6) The current process capability of the MEMS is not enough to support the fabrication of higher-performance detectors, a smaller line width, and a thinner film thickness, which is not conducive to achieving the miniaturization of chips.

### SUMMARY

### (I) Technical Problems to be Solved

The technical problem to be solved by the present disclosure is how to overcome problems of process incompatibility and the impact on performances of an infrared detector caused by the fact that a measuring circuit is fabricated by adopting a CMOS process and an infrared sensing structure is fabricated by using a MEMS process.

### (II) Technical Solutions

In order to solve the above-mentioned technical problems, the present disclosure provides an infrared detector based on a CMOS process, including: a CMOS measuring circuit system and a CMOS infrared sensing structure, wherein both the CMOS measuring circuit system and the CMOS infrared sensing structure are fabricated using the CMOS process, and the CMOS infrared sensing structure is directly fabricated on the CMOS measuring circuit system. The CMOS infrared sensing structure includes at least one sealed release isolation layer above the CMOS measuring circuit system. The sealed release isolation layer is configured to protect the CMOS measuring circuit system from process influence during an etching course of fabricating the CMOS infrared sensing structure. The CMOS fabricating process of the CMOS infrared sensing structure includes a metal interconnection process, an interconnect via process, and an RDL process. The CMOS infrared sensing structure includes at least two metal interconnect layers, at least two dielectric layers and a plurality of interconnect through holes. The dielectric layer includes at least one sacrificial layer and one thermal-sensitive dielectric layer. The metal interconnect layer at least includes a reflecting layer and an electrode layer. The thermal-sensitive dielectric layer includes a thermal-sensitive material with a temperature coefficient of resistance greater than a predetermined value. The thermal-sensitive dielectric layer is configured to convert a temperature change corresponding to infrared radiation absorbed by the thermal-sensitive dielectric layer into a resistance change, and then convert an infrared target signal into an electrically readable signal by the CMOS measuring circuit system, wherein the infrared target signal corresponds to the resistance change. The CMOS infrared sensing structure includes a resonant cavity formed by the reflecting layer and the thermal-sensitive dielectric layer. A suspended micro-bridge structure for controlling heat transfer and a columnar structure with electrical connection and supporting functions, and the CMOS measuring circuit system is configured to measure and process a value of an array resistor formed by one or more CMOS infrared sensing structures, and convert the infrared target signal corresponding to the value of the array resistor into an image electrical signal. The CMOS measuring circuit system includes a bias generation circuit, a column-level analog front-end circuit, and a row-level circuit. An input end of the bias generation circuit is connected to an output end of the row-level circuit. An input end of the column-level analog front-end circuit is connected to an output end of the bias generation circuit. The row-level circuit includes a row-level mirror pixel and a row selection switch. The column-level analog front-end circuit includes a blind pixel; wherein, the row-level circuit is distributed in each pixel and selects a signal to be processed according to a row strobe signal generated by a time sequence generation circuit, and outputs a current signal to the column-level analog front-end circuit to perform current and voltage conversion and output controlled by the bias generation circuit. The row-level circuit outputs a third bias voltage to the bias generation circuit when the row-level circuit is activated by the row selection switch. The bias generation circuit outputs a first bias voltage and a second bias voltage according to an input constant voltage and the third bias voltage. The column-level analog front-end circuit obtains two current paths according to the first bias voltage and the second bias voltage, performs transimpedance amplification on a difference between the two current paths, and outputs an output voltage representing the difference.

In some embodiments, the CMOS infrared sensing structure is fabricated in an upper layer or in the same layer of the metal interconnection layer of the CMOS measuring circuit system.

In some embodiments, the sacrificial layer is configured to enable the CMOS infrared sensing structure to form a hollow structure. The sacrificial layer may include silicon oxide, and the sacrificial layer is etched using a post-CMOS process.

In some embodiments, the post-CMOS process utilizes at least one of gas-phase hydrogen fluoride, carbon tetrafluoride, or trifluoromethane to etch the sacrificial layer.

In some embodiments, the sealed release isolation layer is positioned on an interface between the CMOS measuring circuit system and the CMOS infrared sensing structure and/or positioned in the CMOS infrared sensing structure. The sealed release isolation layer is configured to protect the CMOS measuring circuit system from corrosion during the etching process for releasing the sacrificial layer. A CMOS process anti-corrosion material used in the sealed release isolation layer includes at least one of silicon, germanium, silicon-germanium alloy, amorphous silicon, amorphous germanium, amorphous silicon-germanium, amorphous carbon, silicon carbide, aluminum oxide, silicon nitride, or silicon carbonitride.

In some embodiments, the CMOS infrared sensing structure includes an absorption plate, a beam structure, the reflecting layer, and the columnar structure, wherein the absorption plate is configured to absorb the and convert the infrared signal into an electrical signal. The absorption plate includes a metal interconnection layer and at least one thermal-sensitive dielectric layer. The thermal-sensitive dielectric layer includes a material comprising at least one of amorphous silicon, amorphous germanium, amorphous germanium-silicon, titanium oxide, vanadium oxide, or vanadium titanium oxide. The beam structure and the columnar structure are configured to transmit the electrical signal and to support and connect the absorption plate. The beam structure includes a metal interconnection layer and at least one dielectric layer. The columnar structure is connected to the CMOS measuring circuit system using the metal interconnection process and the interconnect via process. The reflecting layer is configured to reflect the infrared signal and form the resonant cavity with the thermal-sensitive dielectric layer. The reflecting layer includes at least one metal interconnection layer.

In some embodiments, the beam structure is electrically connected to at least two ends of the absorption plate. The CMOS infrared sensing structure includes at least two columnar structures and at least two support bases, and the electrode layer includes at least two electrode terminals.

In some embodiments, the infrared detector is fabricated using 3 nm, 7 nm, 10 nm, 14 nm, 22 nm, 28 nm, 32 nm, 45 nm, 65 nm, 90 nm, 130 nm, 150 nm, 180 nm, 250 nm or 350 nm CMOS process.

In some embodiments, a metal wiring material of the metal interconnection layer includes at least one of aluminum, copper, tungsten, titanium, nickel, chromium, platinum, silver, ruthenium, or cobalt.

### (III) Beneficial Effects

Compared with the prior art, the above technical solutions provided by the embodiments of the present disclosure have the following advantages.

According to the embodiments of the present disclosure, the CMOS measuring circuit system and the CMOS infrared sensing structure are integrally fabricated on a CMOS production line using the CMOS process, compared with an MEMS process, the CMOS does not have a process compatibility problem, so that the technical difficulty faced by the MEMS process is solved, and risks caused by the problems of transportation cost, transportation and the like can be reduced by adopting the CMOS production line process to fabricate the infrared detector. The infrared detector takes the silicon oxide as the sacrificial layer, which is completely compatible with the CMOS process, and the preparation process is simple and easy to control. The CMOS process will not cause the problem that the sacrificial layer polyimide is not released completely, which affects the vacuum degree of the detector chip. Moreover, the subsequent film growth temperature is not limited by the material of the sacrificial layer, so that the multi-layer process design of the sacrificial layer can be realized, and the planarization can be easily realized using the sacrificial layer, reducing the process difficulty and possible risks. The infrared detector fabricated by the integrated CMOS process can achieve the targets of high yield, low cost, high productivity and large-scale integrated production of chips, thus providing a broader application market for the infrared detector. The infrared detector based on the CMOS process can make the infrared detector realize smaller feature size and thinner film thickness, which makes the infrared detector have larger duty cycle, lower thermal conductivity and smaller heat capacity, thus making the infrared detector have higher detection sensitivity, longer detection distance and better detection performance. The infrared detector based on the CMOS process can make a size of the detector pixel smaller, realize a smaller chip area under the same array of pixels, and be more conducive to the miniaturization of chips. The infrared detector based on the CMOS process has the advantages of mature production line, higher control precision, better design requirements, better product consistency, better performance adjustment of circuit chips and better industrial mass production.

It should be understood that the foregoing general description and the following detailed description are exemplary only, and cannot limit the present disclosure.

### BRIEF DESCRIPTION OF THE DRAWINGS

The accompanying drawings herein are incorporated in and constitute a part of this description, illustrate the embodiments in conformity with the present disclosure, and serve to explain the principles of the present disclosure together with the description.

In order to illustrate the technical solutions in the embodiments of the present disclosure or the prior art more clearly, the drawings to be used in the description of the embodiments or the prior art will be briefly described below. Obviously, those of ordinary skills in the art can also obtain other drawings based on these drawings without going through any creative work.

FIG. 1 is a schematic three-dimensional structural diagram of an infrared detector in accordance with some embodiments of the present disclosure;

FIG. 2 is a schematic diagram of a cross-sectional structure of the infrared detector in accordance with some embodiments of the present disclosure;

FIG. 3 is a schematic cross-sectional structural diagram of another infrared detector in accordance with some embodiments of the present disclosure;

FIG. 4 is a schematic cross-sectional structural diagram of another infrared detector in accordance with some embodiments of the present disclosure;

FIG. 5 is a schematic structural diagram of a CMOS measuring circuit system in accordance with some embodiments of the present disclosure;

FIG. 6 is a schematic cross-sectional structural diagram of another infrared detector in accordance with some embodiments of the present disclosure; and

FIG. 7 is a three-dimensional schematic diagram of another infrared detector in accordance with some embodiments of the present disclosure.

### DETAILED DESCRIPTION OF THE EMBODIMENTS

In order to make the objectives, the technical solutions and the advantages of the embodiments of the present disclosure clearer, the technical solutions in the embodiments of the present disclosure will be clearly and completely described below. Apparently, the described embodiments are merely certain embodiments of the present disclosure, rather than all of the embodiments. Based on the embodiments in the present disclosure, all other embodiments obtained by those of ordinary skills in the art without going through any creative work shall fall within the protection scope of the present disclosure.

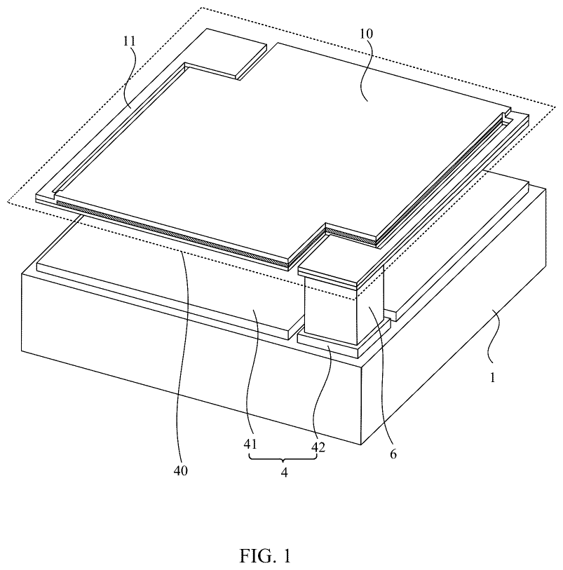

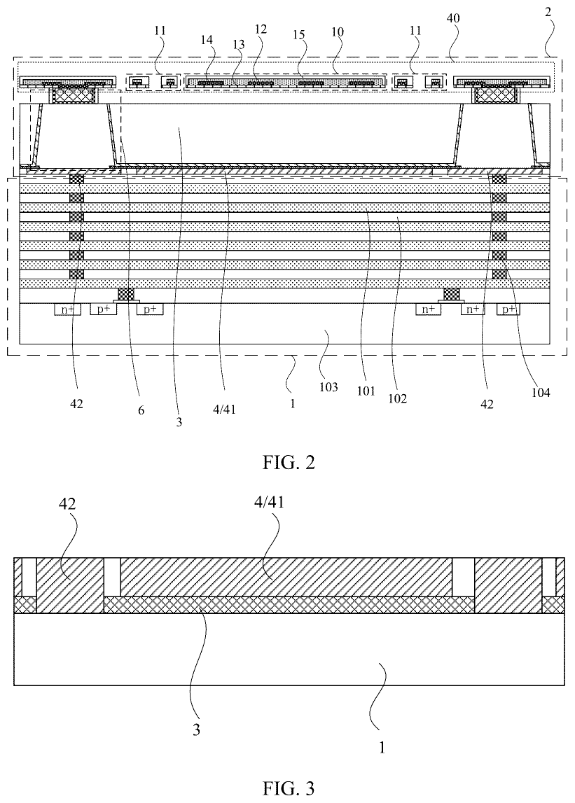

FIG. 1 is a schematic three-dimensional structure diagram of an infrared detector in accordance with some embodiments of the present disclosure. FIG. 2 is a schematic cross-sectional structural diagram of the infrared detector in accordance with some embodiments of the present disclosure. With reference to FIG. 1 and FIG. 2, the infrared detector based on the CMOS includes a CMOS measuring circuit system 1 and a CMOS infrared sensing structure 2. Both the CMOS measuring circuit system 1 and the CMOS infrared sensing structure 2 are fabricated using the CMOS process, and the CMOS infrared sensing structure 2 is directly fabricated on the CMOS measuring circuit system 1.

Specifically, the CMOS infrared sensing structure 2 is configured to convert an external infrared signal into an electrical signal and transmit the electrical signal to the CMOS measuring circuit system 1. The CMOS measuring circuit system 1 reflects temperature information corresponding to the infrared signal according to the electrical signal to implement a temperature detection function of the infrared detector. Both the CMOS measuring circuit system 1 and the CMOS infrared sensing structure 2 are fabricated using the CMOS process, and the CMOS infrared sensing structure 2 is directly fabricated on the CMOS measuring circuit system 1, which means that the CMOS measuring circuit system 1 may be fabricated using the CMOS process firstly, and the CMOS infrared sensing structure 2 may then be fabricated continuously using the CMOS process, a CMOS production line and parameters of various processes compatible with the production line.

Therefore, the embodiments of the present disclosure realize the integral fabrication of the CMOS measuring circuit system 1 and the CMOS infrared sensing structure 2 on the CMOS production line using the CMOS process, and compared with the MEMS process, the CMOS does not have a process compatibility problem, thereby solving the technical difficulty faced by the MEMS process, and fabricating the infrared detector using the CMOS production line process can also reduce a transportation cost and reduce a risk caused by the problems of transportation and the like. The infrared detector uses silicon oxide as the sacrificial layer. Silicon oxide may be completely compatible with the CMOS process, making the preparation process simple and easy to control. Additionally, the CMOS process will not cause the problem that the sacrificial layer polyimide is not released completely, which can affect the vacuum level of the detector chip. Moreover, the subsequent film growth temperature is not limited by the material of the sacrificial layer, so that the multi-layer process design of the sacrificial layer can be realized, and the planarization can be easily realized using the sacrificial layer, thereby reducing the process difficulty and possible risks. The infrared detector fabricated by the integrated CMOS process can achieve the goals of high yield, low cost, high productivity and large-scale integrated production of chips, thus providing a broader application market for the infrared detector. The infrared detector based on the CMOS process can make the infrared detector realize smaller feature size and thinner film thickness, which makes the infrared detector have larger duty cycle, lower thermal conductivity and smaller heat capacity, thus making the infrared detector have higher detection sensitivity, longer detection distance and better detection performance. The infrared detector based on the CMOS process can make a size of the detector pixel smaller, realize a smaller chip area under the same array of pixels, and be more conducive to the miniaturization of chips. The infrared detector based on the CMOS process has the advantages of mature production line, higher control precision, better design requirements, better product consistency, better performance adjustment of circuit chips and better industrial mass production.

Referring to FIG. 1 and FIG. 2, the CMOS infrared sensing structure 2 includes a reflecting layer 4, an infrared conversion structure 40 and a plurality of columnar structures 6 positioned on the CMOS measuring circuit system 1. The columnar structures 6 are positioned between the reflecting layer 4 and the infrared conversion structure 40. The reflecting layer 4 includes a reflecting plate 41 and a support base 42, and the infrared conversion structure 40 is electrically connected to the CMOS measuring circuit system 1 through the columnar structures 6 and the support base 42.

Specifically, the columnar structure 6 is positioned between the reflecting layer 4 and the infrared conversion structure 40 and is configured to support the infrared conversion structure 40 after the sacrificial layer on the CMOS measuring circuit system 1 is released. The sacrificial layer is positioned between the reflecting layer and the infrared conversion structure 40. The columnar structure 6 is a metal structure. An electrical signal converted by the infrared conversion structure 40 through the infrared signal is transmitted to the CMOS measuring circuit system 1 through the corresponding columnar structure 6 and the corresponding support base 42, and the CMOS measuring circuit system 1 processes the electrical signal to reflect the temperature information, which may realize non-contact infrared temperature detection of the infrared detector. The CMOS infrared sensing structure 2 outputs a positive electrical signal and a ground electrical signal through different electrode structures. The positive electrical signal and the ground electrical signal are transmitted to the support base 42 connected electrically to the columnar structures 6 through different columnar structures 6. FIG. 1 and FIG. 2 illustratively show that the CMOS infrared sensing structure 2 includes two columnar structures 6 along a direction parallel to the CMOS measuring circuit system 1. One columnar structure 6 may be configured to transmit the positive electrical signal and the other columnar structure 6 may be configured to transmit the ground electrical signal. The CMOS infrared sensing structure 2 can also be configured to include four columnar structures 6, which are paired as a group to transmit the positive electrical signal and the ground electrical signal, respectively. In addition, the reflecting layer 4 includes a reflecting plate 41 and the support base 42, a part of the reflecting layer 4 is configured to serve as a dielectric for electrically connecting the columnar structure 6 and the CMOS measuring circuit system 1 and may be the support base 42. The reflecting plate 41 is configured to reflect the infrared signal to the infrared conversion structure 40 and cooperate with the resonant cavity formed between the reflecting layer 4 and the infrared conversion structure 40 to achieve secondary absorption of the infrared signal to improve an infrared absorption rate of the infrared detector and optimize an infrared detection performance of the infrared detector.

Referring to FIG. 1 and FIG. 2, the infrared conversion structure includes an absorption plate 10 and a plurality of beam structures 11. The absorption plate 10 is configured to convert an infrared signal into an electrical signal and is electrically connected to the columnar structure 6 through the beam structure 11. For example, both the absorption plate 10 and the beam structure 11 may be provided with a thermal-sensitive layer 12, and a material of the thermal-sensitive layer 12 includes at least one of amorphous silicon, amorphous carbon, amorphous germanium, amorphous silicon-germanium, titanium oxide, vanadium oxide or vanadium titanium oxide. Specifically, the absorption plate 10 is configured to convert an infrared signal into an electrical signal and electrically connect to the columnar structure 6 through the beam structure 11. The absorption plate 10 includes a support layer 13, an electrode layer 14, a thermal-sensitive layer 12 and a passivation layer 15. The beam structure 11 may similarly include a support layer 13, an electrode layer 14 and a passivation layer 15. The beam structure 11 may also include a thermal-sensitive layer 12. The support layer 13 is positioned on one side of the passivation layer 15 close to the CMOS measuring circuit system 1, and the electrode layer 14 and the thermal-sensitive layer 12 are positioned between the support layer 13 and the passivation layer 15. The passivation layer 15 covers the electrode layer 14, and the thermal-sensitive layer 12 covers a position where the beam structure 11 is positioned. Thermal conductivity of the beam structure 11 can be reduced due to the characteristic of low thermal conductivity of thermo-sensitive materials such as amorphous silicon, amorphous germanium, or amorphous silicon-germanium. The thermal-sensitive layer 12 may replace the support layer 13 as a support material of the beam structure 11 and may also replace the passivation layer 15 as an electrode protective material of the beam structure 11.

Specifically, the support layer 13 is configured to support an upper film layer in the infrared conversion structure 40 after releasing the sacrificial layer, the thermal-sensitive layer 12 is configured to convert an infrared temperature detection signal into an infrared detection electrical signal, the electrode layer 14 is configured to transmit the infrared detection electrical signal converted by the thermal-sensitive layer 12 to the CMOS measuring circuit system 1 through the beam structures 11 on left and right sides, and the two beam structures 11 transmit positive and negative signals of the infrared detection electrical signal respectively. A reading circuit in the CMOS measuring circuit system 1 realizes non-contact infrared temperature detection by analyzing the acquired infrared detection electrical signal, and the passivation layer 15 is configured to protect the electrode layer 14 from oxidation or corrosion. In addition, the thermal-sensitive layer 12 may be positioned above the electrode layer 14, and may also be positioned below the electrode layer 14. Corresponding to the absorption plate 10, the thermal-sensitive layer 12 and the electrode layer 14 may be positioned in a closed space formed by the support layer 13 and the passivation layer 15 to protect the thermal-sensitive layer 12 and the electrode layer 14 in the absorption plate 10; and corresponding to the beam structure 11, the electrode layer 14 may be positioned in the closed space formed by the support layer 13 and the passivation layer 15 to protect the electrode layer 14 in the beam structure 11.

Illustratively, a material of the thermal-sensitive layer 12 may include at least one of amorphous silicon, amorphous germanium, amorphous silicon-germanium, titanium oxide, vanadium oxide or titanium oxide vanadium. A material of the support layer 13 may include one or more of amorphous carbon, aluminum oxide, amorphous silicon, amorphous germanium or amorphous germanium-silicon. A material of the electrode layer 14 may include one or more of titanium, titanium nitride, tantalum, tantalum nitride, titanium-tungsten alloy, nickel-chromium alloy, nickel-silicon alloy, nickel or chromium. And a material of the passivation layer 15 may include one or more of amorphous carbon, aluminum oxide, amorphous silicon, amorphous germanium or amorphous germanium-silicon. Moreover, the absorption plate 10 includes the thermal-sensitive layer 12. When the material of the thermal-sensitive layer 12 is amorphous silicon, amorphous carbon, amorphous germanium or amorphous silicon-germanium, the thermal-sensitive layer 12 may replace the support layer 13 and/or the passivation layer 15 on the beam structure 11 as the amorphous silicon due to that the amorphous germanium or the amorphous silicon-germanium has a smaller thermal conductivity and it is beneficial to reducing a thermal conductivity of the beam structure 11 and further improving an infrared responsivity of the infrared detector.

Referring to FIG. 1 and FIG. 2, the CMOS infrared sensing structure includes at least one sealed release isolation layer 3 arranged above the CMOS measuring circuit system 1. The sealed release isolation layer 3 is configured to protect the CMOS measuring circuit system 1 from process influence during a release etching course of fabricating the CMOS infrared sensing structure 2. In some embodiments, the sealed release isolation layer 3 is positioned on an interface between the CMOS measuring circuit system 1 and the CMOS infrared sensing structure 2 and/or positioned in the CMOS infrared sensing structure 2. The sealed release isolation layer 3 is configured to protect the CMOS measuring circuit system 1 from erosion when the sacrificial layer is released by the etching process. A CMOS process anti-corrosion material used in the sealed release isolation layer 3 includes at least one of silicon, germanium, silicon-germanium alloy, amorphous silicon, amorphous germanium, amorphous silicon-germanium, amorphous carbon, silicon carbide, aluminum oxide, silicon nitride, or silicon carbonitride.

As shown in FIG. 2, the sealed release isolation layer 3 is positioned in the CMOS infrared sensing structure 2. The sealed release isolation layer 3, for example, may be positioned above a metal interconnection layer of the reflecting layer 4. The sealed release isolation layer 3 covers the columnar structure 6. By setting the sealed release isolation layer 3 to cover the columnar structure 6, on one hand, the sealed release isolation layer 3 may be used as a support at the columnar structure 6, which improves stability of the columnar structure 6 and ensures electrical connection between the columnar structure 6 and the infrared conversion structure 40 and the support base 42. On the other hand, the sealed release isolation layer 3 covering the columnar structure 6 can reduce contact between the columnar structure 6 and an external environment, reduce a contact resistance between the columnar structure 6 and the external environment, further reduce noises of an infrared detector pixel, and improve detection sensitivity of the infrared detection sensor. In addition, the resonant cavity of the infrared detector is realized by a vacuum cavity after releasing the silicon oxide sacrificial layer. The reflecting layer 4 can serve as the reflecting layer of the resonant cavity, and the sacrificial layer is positioned between the reflecting layer 4 and the infrared conversion structure 40. When at least one sealed release isolation layer 3 positioned on the reflecting layer 4 may select silicon, germanium, silicon-germanium alloy, amorphous silicon, amorphous germanium or amorphous silicon-germanium as a part of the resonant cavity, a reflecting effect of the reflecting layer will not be affected, and a height of the resonant cavity can be reduced, thereby reducing a thickness of the sacrificial layer and reducing a release difficulty of the sacrificial layer made of silicon oxide. In addition, the sealed release isolation layer 3 and the columnar structure 6 are arranged to form the closed structure, which completely separates the CMOS measuring circuit system 1 from the sacrificial layer, thus realizing the protection for the CMOS measuring circuit system 1.

FIG. 3 is a schematic cross-sectional structural diagram of an infrared detector in accordance with another implementation of the present disclosure. Unlike the infrared detector of the structure shown FIG. 2, the infrared detector of the structure shown in FIG. 3 has the sealed release isolation layer 3 positioned on the interface between the CMOS measuring circuit system 1 and the CMOS infrared sensing structure 2. For example, the sealed release isolation layer 3 is positioned between the reflecting layer 4 and the CMOS measuring circuit system 1, which means that the sealed release isolation layer 3 is positioned below the metal interconnection layer of the reflecting layer 4, and the support base 42 is electrically connected to the CMOS measuring circuit system 1 via a through hole penetrating through the sealed release isolation layer 3. Specifically, since the CMOS measuring circuit system 1 and the CMOS infrared sensing structure 2 are both fabricated using the CMOS process, after the CMOS measuring circuit system 1 is fabricated, a wafer containing the CMOS measuring circuit system 1 is transmitted to next process to fabricate the CMOS infrared sensing structure 2. Because silicon oxide is the most commonly used dielectric material in the CMOS process, silicon oxide is mostly used as an insulating layer between the metal layers on the CMOS circuit. Therefore, if there is no isolation layer as a barrier when etching the silicon oxide with a thickness of about 2 μm, the circuit will be seriously affected. In order to ensure that a silicon oxide dielectric on the CMOS measuring circuit system is not etched when releasing the sacrificial layer silicon oxide, the sealed release isolation layer 3 is arranged. After fabricating and forming the CMOS measuring circuit system 1, the sealed release isolation layer 3 is fabricated and formed on the CMOS measuring circuit system 1, and the CMOS measuring circuit system 1 is protected by the sealed release isolation layer 3. In order to ensure electrical connection between the support base 42 and the CMOS measuring circuit system 1, after fabricating and forming the sealed release isolation layer 3, a through hole is formed in an area of the sealed release isolation layer 3 corresponding to the support base 42 by an etching process, and the electrical connection between the support base 42 and the CMOS measuring circuit system 1 is realized through the through hole. In addition, the sealed release isolation layer 3 and the support base 42 are provided to form the closed structure to completely separate the CMOS measuring circuit system 1 from the sacrificial layer for realizing protection of the CMOS measuring circuit system 1.

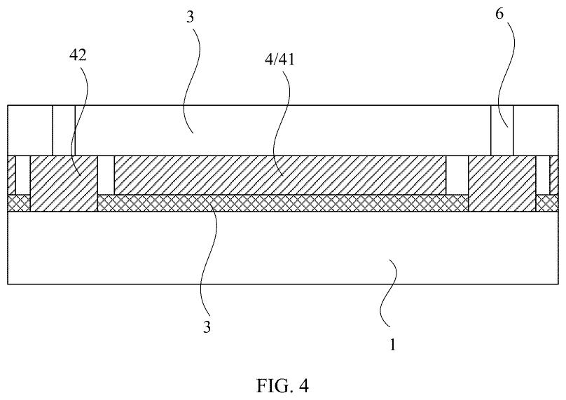

FIG. 4 is a schematic cross-sectional structural diagram of another infrared detector in accordance with some embodiments of the present disclosure. Unlike the infrared detector of the structure shown FIG. 3, the infrared detector of the structure shown in FIG. 4 has at least one sealed release isolation layer 3 arranged at the interface between the CMOS measuring circuit system 1 and the CMOS infrared sensing structure 2, and at least one sealed release isolation layer 3 is arranged in the CMOS infrared sensing structure 2, which means that at least one sealed release isolation layer 3 is arranged between the reflecting layer 4 and the CMOS measuring circuit system 1, and at least one sealed release isolation layer 3 is arranged on the reflecting layer 4. The effects are the same as previously described and will not be repeated in detail here.

Exemplarily, a material of the sealed release isolation layer 3 may include at least one of silicon, germanium, silicon-germanium alloy, amorphous silicon, amorphous germanium, amorphous silicon-germanium, amorphous carbon, silicon carbide, aluminum oxide, silicon nitride or silicon carbonitride, and a thickness of the sealed release isolation layer 3 is greater than 100 Å, and less than 2,000 Å. Specifically, silicon, germanium, silicon-germanium alloy, amorphous silicon, amorphous germanium, amorphous silicon-germanium, amorphous carbon, silicon carbide, aluminum oxide, silicon nitride and silicon carbonitride are all CMOS process anti-corrosion materials, which means that, these materials are not etched by reagents used to release the sacrificial layer. Therefore, the sealed release isolation layer 3 may be configured to protect the CMOS measuring circuit system 1 from corrosion when releasing the sacrificial layer in the etching process. In addition, it may be provided that the sealed release isolation layer 3 covers the CMOS measuring circuit system 1, and the sealed release isolation layer 3 is also configured to protect the CMOS measuring circuit system 1 from process influence during an etching process course of fabricating the CMOS infrared sensing structure 2. In addition, when the reflecting layer 4 is provided with at least one sealed release isolation layer 3, a material of the sealed release isolation layer 3 includes at least one of silicon, germanium, silicon-germanium alloy, amorphous silicon, amorphous germanium, amorphous silicon-germanium, amorphous carbon, silicon carbide, aluminum oxide, silicon nitride or silicon carbonitride. A thickness of a first dielectric layer is greater than 100 Å, and less than 2,000 Å. The sealed release isolation layer 3 hardly affects a reflecting course in the resonant cavity while the sealed release isolation layer 3 is arranged to improve the stability of the columnar structure 6, which can prevent the sealed release isolation layer 3 from affecting a reflecting course of the resonant cavity, and further avoid the influence of the sealed release isolation layer 3 on the detection sensitivity of the infrared detector.

Referring to FIG. 1 to FIG. 4, the CMOS fabricating process of the CMOS infrared sensing structure 2 includes a metal interconnection process, an interconnect via process and an RDL process. The CMOS infrared sensing structure 2 includes at least two metal interconnect layers, at least two dielectric layers and a plurality of interconnect through holes. The dielectric layer at least includes one sacrificial layer and one thermal-sensitive dielectric layer. The thermal-sensitive dielectric layer at least includes a thermal-sensitive layer 12 and may also include a support layer 13 and/or a passivation layer 15. The metal interconnection layer at least includes a reflecting layer 4 and an electrode layer 14. The thermal-sensitive dielectric layer includes a thermal-sensitive material with a temperature coefficient of resistance greater than a predetermined value, wherein the temperature coefficient of resistance may be, for example, greater than or equal to 0.015/K. The thermal-sensitive material with the temperature coefficient of resistance greater than the predetermined value forms the thermal-sensitive layer 12 in the thermal-sensitive dielectric layer. The thermal-sensitive dielectric layer is configured to convert a temperature change corresponding to infrared radiation absorbed by the thermal-sensitive dielectric layer into a resistance change, and then convert an infrared target signal into an electrically readable signal by the CMOS measuring circuit system 1.

Specifically, the metal interconnection process is configured to achieve the electrically connection between an upper metal interconnection layer and a lower metal interconnection layer. The interconnect via process is configured to form interconnect through holes for connecting the upper metal interconnection layer with the lower metal interconnection layer. The RDL process is a rewiring layer process, specifically referring to re-distributing one layer of metal above the metal of the top layer of the circuit and electrically connecting it to the metal of the top layer of the circuit with a tungsten column. Using the RDL process, the reflecting layer 4 can be re-fabricated in the infrared detector on the metal of the top layer of the CMOS measuring circuit system 1, and the support base 42 on the reflecting layer 4 is electrically connected to the metal of the top layer of the CMOS measuring circuit system 1. In addition, the thermal-sensitive dielectric layer includes a thermal-sensitive material with a temperature coefficient of resistance greater than a predetermined value, which may be, for example, greater than or equal to 0.015/K, which is beneficial to improving the detection sensitivity of the infrared detector.

In addition, as shown in FIG. 2, the CMOS fabricating process of the CMOS measuring circuit system 1 may also include a metal interconnection process and an interconnect via process, the CMOS measuring circuit system 1 includes metal interconnection layers 101 arranged at interval, a dielectric layer 102, and a silicon substrate 103 positioned at the bottom, and the upper and lower metal interconnection layers 101 are electrically connected through the through hole 104.

Referring to FIG. 1 to FIG. 4, the CMOS infrared sensing structure 2 includes the resonant cavity formed by the reflecting layer 4 and the thermal-sensitive dielectric layer, a suspended micro-bridge structure for controlling heat transfer and the columnar structure 6 having the electrical connection and supporting functions. The CMOS measuring circuit system 1 is configured to measure and process the value of the array resistor formed by one or more CMOS infrared sensing structures 2, and convert the infrared target signal corresponding to the value of the array resistor into the image electrical signal.

Specifically, the resonant cavity may be formed, for example, by a cavity between the reflecting layer 4 and the absorption plate 10, and infrared light is reflected back and forth in the resonant cavity through the absorption plate 10 to improve the detection sensitivity of the infrared detector. Due to the arrangement of the columnar structure 6, the beam structure 11 and the absorption plate 10 form the suspended micro-bridge structure for controlling heat transfer. The columnar structure 6 not only electrically connects the support base 42 and the corresponding beam structure 11, but also supports the infrared conversion structure 40 positioned on the columnar structure 6.

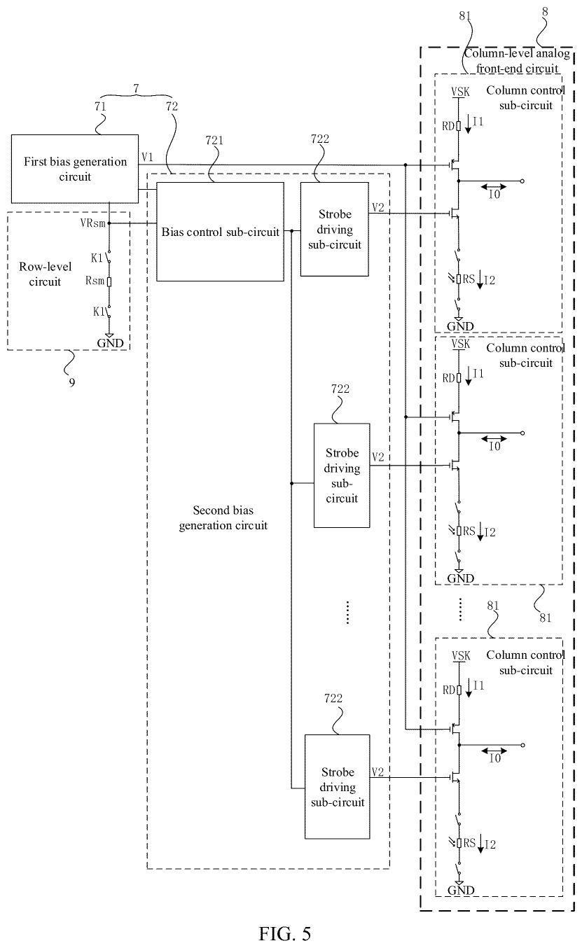

FIG. 5 is a schematic structural diagram of a CMOS measuring circuit system in accordance with some embodiments of the present disclosure. Referring to FIG. 1 to FIG. 5, the CMOS measuring circuit system 1 includes a bias generation circuit 7, a column-level analog front-end circuit 8 and a row-level circuit 9. An input end of the bias generation circuit 7 is connected to an output end of the row-level circuit 9, and an input end of the column-level analog front-end circuit 8 is connected to an output end of the bias generation circuit 7. The row-level circuit 9 includes a row-level mirror pixel Rsm and a row selection switch K1. The column-level analog front-end circuit 8 includes a blind pixel RD. The row-level circuit 9 is distributed in each pixel and selects a signal to be processed according to a row strobe signal generated by a time sequence generation circuit, and outputs a current signal to the column-level analog front-end circuit 8 to perform current and voltage conversion and output under the action of the bias generation circuit 7. When the row-level circuit 9 is activated by the row selection switch K1, a third bias voltage VRsm is output to the bias generation circuit 7. The bias generation circuit 7 outputs a first bias voltage V1 and a second bias voltage V2 according to an input constant voltage and the third bias voltage VRsm. The column-level analog front-end circuit 8 obtains two current paths according to the first bias voltage V1 and the second bias voltage V2 and performs transimpedance amplification on a difference between the two current paths, which is then output as an output voltage.

Specifically, the row-level circuit 9 includes the row-level mirror pixel Rsm and the row selection switch K1. The row-level circuit 9 is configured to generate the third bias voltage VRsm according to an activation state of the row selection switch K1. Illustratively, the row-level mirror pixel Rsm may be subjected to shading treatment, so that the row-level mirror pixel Rsm is regularly irradiated by a shade with a temperature constant equal to a substrate temperature. The row selection switch K1 may be implemented using a transistor. When the row selection switch K1 is closed, the row-level mirror pixel Rsm is connected to the bias generation circuit 7. That is, the row-level circuit 9 outputs the third bias voltage VRsm to the bias generation circuit 7 when the row-level circuit is activated by the row selection switch K1. The bias generation circuit 7 may include a first bias generation circuit 71 and a second bias generation circuit 72. The first bias generation circuit 71 is configured to generate the first bias voltage V1 according to an input constant voltage, and the input constant voltage may be a positive power supply signal with a constant voltage, for example. The second bias generation circuit 72 may include a bias control sub-circuit 721 and a plurality of strobe driving sub-circuits 722. The bias control sub-circuit 721 is configured to control the strobe driving sub-circuits 722 to generate respective second bias voltages V2 according to the third bias voltage VRsm.

The column-level analog front-end circuit 8 includes a plurality of column control sub-circuits 81, and the column control sub-circuits 81 are arranged corresponding to the strobe driving sub-circuits 722. For example, the column control sub-circuits 81 and the strobe driving sub-circuits 722 may be arranged in a one-to-one correspondence, and the strobe driving sub-circuits 722 are configured to provide the second bias voltage V2 to the corresponding column control sub-circuits 81 according to the activation states thereof. For example, it may be set that when the strobe driving sub-circuits 722 are selected, the strobe driving sub-circuits 722 provide the second bias voltage V2 to the corresponding column control sub-circuits 81. When the strobe driving sub-circuits 722 are not selected, the strobe driving sub-circuits 722 stop providing the second bias voltage V2 to the corresponding column control sub-circuits 81.

The column-level analog front-end circuit 8 includes an effective pixel RS and a blind pixel RD. The column control sub-circuit is configured to generate a first current I1 according to the first bias voltage V1 and the blind pixel RD, and generate a second current I2 according to the second bias voltage V2 and the effective pixel RS, and perform transimpedance amplification on a difference between the first current I1 and the second current I2 and then output the difference. The row-level mirror pixel Rsm has the same temperature drift as the effective pixel RS at the same ambient temperature.

Exemplarily, the row-level mirror pixel Rsm is thermally insulated from the CMOS measuring circuit system 1 and shading processing is performed on the row-level mirror pixel Rsm. The row-level mirror pixel Rsm is exposed to a fixed radiation from the shade with a temperature constant equal to the substrate temperature. The absorption plate 10 of the effective pixel RS is thermally insulated from the CMOS measuring circuit system 1, and the effective pixel RS accepts external radiation. The row-level mirror pixel Rsm and the absorption plate 10 of the effective pixel RS are both thermally insulated from the CMOS measuring circuit system 1, so that the row-level mirror pixel Rsm and the effective pixel RS both have a self-heating effect.

When the corresponding row-level mirror pixel Rsm is selected by the row selection switch K1, resistance values of both the row-level mirror pixel Rsm and the effective pixel RS may change due to Joule heating. However, when the row-level mirror pixel Rsm and the effective pixel RS receive the same fixed radiation, the resistance values of the row-level mirror pixel Rsm and the effective pixel RS are the same, temperature coefficients of the two are the same, and temperature drifts of the two are the same at the same environmental temperature. The synchronous changes in these values effectively utilize the characteristic that the temperature drifts of the row-level mirror pixel Rsm and the effective pixel RS are the same at the same environmental temperature, allowing for effective compensation of the resistance changes of the row-level mirror pixel Rsm and the effective pixel RS due to the self-heating effect, and realize stable output of the reading circuit.

In addition, by configuring the second bias generation circuit 72 to include the bias control sub-circuit 721 and the plurality of strobe driving sub-circuits 722, the bias control sub-circuit 721 is configured to control the strobe driving sub-circuits 722 to respectively generate the corresponding second bias voltage V2 according to the row control signal, so that each row of pixels has one path of drive for driving the row of pixels individually, thereby reducing the requirement for the second bias voltage V2, thereby improving the driving capability of the bias generation circuit 7, and facilitating driving a larger-scale infrared detector pixel array using the reading circuit. In addition, the specific detailed working principles of the CMOS measuring circuit system 1 are well-known to a person skilled in the art, and details are not described herein again.

In some embodiments, the CMOS infrared sensing structure 2 can be arranged on the upper layer or the same layer of the metal interconnection layer of the CMOS measuring circuit system 1. Specifically, the metal interconnection layer of the CMOS measuring circuit system 1 here may be the top metal layer in the CMOS measuring circuit system 1. Referring to FIG. 1 to FIG. 4, the CMOS infrared sensing structure 2 may be arranged on the metal interconnection layer of the CMOS measuring circuit system 1, and the CMOS infrared sensing structure 2 is electrically connected to the CMOS measuring circuit system 1 through the support base 42 positioned on the upper layer of the metal interconnection layer of the CMOS measuring circuit system 1, to transmit the electrical signals converted by the infrared signals to the CMOS measuring circuit system 1.

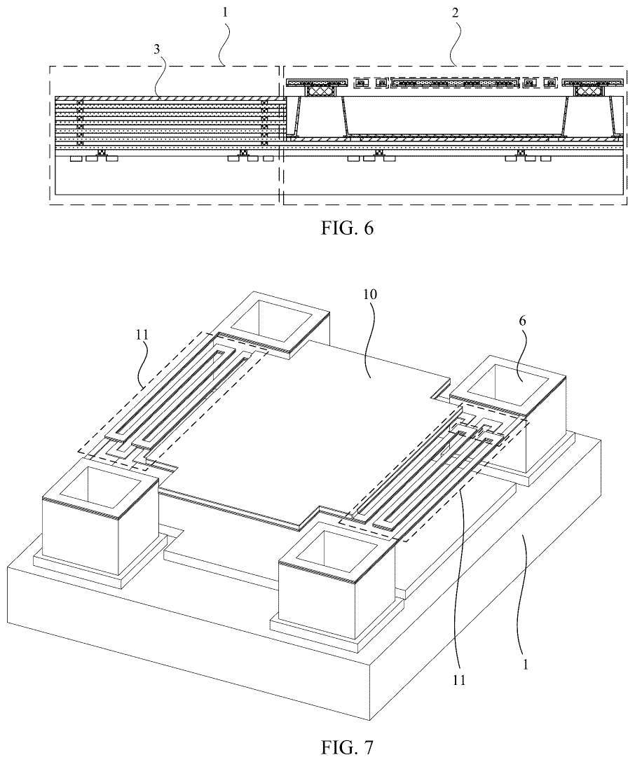

FIG. 6 is a schematic cross-sectional structural diagram of another infrared detector in accordance with some embodiments of the present invention. As shown in FIG. 6, the CMOS infrared sensing structure 2 may also be fabricated on the same layer of the metal interconnection layer of the CMOS measuring circuit system 1, that is, the CMOS measuring circuit system 1 and the CMOS infrared sensing structure 2 are arranged on the same layer, as shown in FIG. 6, the CMOS infrared sensing structure 2 may be provided on one side of the CMOS measuring circuit system 1, and a top portion of the CMOS measuring circuit system 1 may also be provided with the sealed release isolation layer 3 to protect the CMOS measuring circuit system 1.

In some embodiments, in combination with FIG. 1 to FIG. 6, the sacrificial layer is configured to enable the CMOS infrared sensing structure 2 to form a hollow structure, a material of the sacrificial layer is silicon oxide, and the sacrificial layer is etched using a post-CMOS process. For example, the post-CMOS process may employ at least one of gas phase hydrogen fluoride, carbon tetrafluoride, or trifluoromethane, which are corrosive to silicon oxide, to etch the sacrificial layer. Specifically, the sacrificial layer (not shown in FIG. 1 to FIG. 4) is provided between the reflecting layer 4 and the beam structure 11. When the sealed release isolation layer 3 is arranged on the reflecting layer 4, a sacrificial layer is provided between the sealed release isolation layer 3 and the beam structure 11, and a material of the sacrificial layer is silicon oxide to be compatible with the CMOS process. The post-CMOS process may be used, which means that the post-CMOS process is configured to etch the sacrificial layer to release the sacrificial layer in the final infrared detection chip product.

In some embodiments, referring to FIG. 1 to FIG. 4, the CMOS infrared sensing structure 2 includes an absorption plate 10, a beam structure 11, a reflecting layer 4 and a columnar structure 6. The absorption plate 10 is configured to absorb an infrared target signal and convert the infrared target signal into the electrical signal. The absorption plate 10 includes a metal interconnection layer and at least one thermal-sensitive dielectric layer. A material of the thermal-sensitive dielectric layer includes at least one of amorphous silicon, amorphous germanium, amorphous germanium-silicon, titanium oxide, vanadium oxide, or vanadium titanium oxide. The metal interconnection layer in the absorption plate 10 is an electrode layer 14 in the absorption plate 10 and is configured to transmit the obtained electrical signal converted from the infrared signal. The thermal-sensitive dielectric layer at least includes a thermal-sensitive layer 12 and may also include a support layer 13 and a passivation layer 15. A material of the thermal-sensitive dielectric layer includes at least one of amorphous silicon, amorphous germanium, amorphous germanium-silicon, titanium oxide, vanadium oxide, or vanadium titanium oxide, which means that, a material of the thermal-sensitive layer 12 includes at least one of amorphous silicon, amorphous germanium, amorphous germanium-silicon, titanium oxide, vanadium oxide or vanadium titanium oxide.

The beam structure 11 and the columnar structure 6 are configured to transmit an electrical signal and configured to support and connect the absorption plate 10. The electrode layer 14 in the absorption plate 10 includes two patterned electrode structures. The two patterned electrode structures output a positive electrical signal and a ground electrical signal, respectively. The positive electrical signal and the ground electrical signal are transmitted to the support base electrically connected to the columnar structure 6 through different beam structures 11 and different columnar structures 6, so as to be transmitted to the CMOS measuring circuit system 1. The beam structure 11 includes a metal interconnection layer and at least one dielectric layer, the metal interconnection layer in the beam structure 11 is an electrode layer in the beam structure 11, and the electrode layer 14 in the beam structure 11 is electrically connected to the electrode layer 14 in the absorption plate 10. The dielectric layer in the beam structure 11 may include a support layer 13 and a passivation layer 15.

The columnar structure 6 is connected to the beam structure 11 and the CMOS measuring circuit system 1 by the metal interconnection process and the interconnect via process. An upper part of the columnar structure needs to be electrically connected to the electrode layer 14 in the corresponding beam structure 11 via a through hole penetrating through the support layer 13 in the beam structure 11, while a lower part of the columnar structure 6 needs to be electrically connected to the corresponding support base 42 via a through hole penetrating through the dielectric layer on the support base 42. The reflecting plate 41 is configured to reflect the infrared signal and form the resonant cavity with the thermal-sensitive dielectric layer, which means that, the reflecting plate 41 is configured to reflect the infrared signal and form the resonant cavity with the thermal-sensitive dielectric layer. The reflecting layer 4 includes at least one metal interconnect layer, and the metal interconnect layer is configured to form the support base 42 and is also configured to form the reflecting plate 41. In addition, the columnar structure 6 may include one layer of independent columnar structure as shown in FIG. 1 or a plurality of layers of independent columnar structures as shown in FIG. 2, which is beneficial to optimizing steepness of the columnar structure 6.

In some embodiments, the beam structure 11 may be electrically connected to at least two ends of the absorption plate 10, the CMOS infrared sensing structure 2 includes at least two columnar structures 6 and at least two support bases 42, and the electrode layer 14 includes at least two electrode terminals. Specifically, as shown in FIG. 1, the beam structure 11 is electrically connected to the two ends of the absorption plate 10. Each beam structure 11 is electrically connected to one end of the absorption plate 10. The CMOS infrared sensing structure 2 includes two columnar structures 6, and the electrode layer 14 includes at least two electrode terminals. At least a part of the electrode terminals may transmit positive signals, and at least another part of the electrode terminals may transmit negative signals, which are transmitted to the support base 42 through the corresponding beam structure 11 and the corresponding columnar structure 6.

FIG. 7 is a schematic three-dimensional structural diagram of another infrared detector in accordance with some embodiments of the present disclosure. As shown in FIG. 7, the beam structure 11 may be electrically connected to four ends of the absorption plate 10, and each beam structure 11 is electrically connected to two ends of the absorption plate 10. The CMOS infrared sensing structure 2 includes four columnar structures 6, and one beam structure 11 is connected to two columnar structures 6. It should be noted that in the embodiments of the present disclosure, the number of the ends of the absorption plate 10 connected to the beam structure 11 is not specifically limited, and it is only necessary to ensure that the beam structure 11 is corresponding to the electrode terminal, and the beam structure 11 is configured to transmit an electrical signal output by the corresponding electrode terminal.

In some embodiments, the infrared detector may be configured to be fabricated using 3 nm, 7 nm, 10 nm, 14 nm, 22 nm, 28 nm, 32 nm, 45 nm, 65 nm, 90 nm, 130 nm, 150 nm, 180 nm, 250 nm, or 350 nm CMOS process. These sizes characterize process nodes of an integrated circuit, i.e., the feature sizes in an integrated circuit process.

In some embodiments, a metal wiring material of the metal interconnection layer in the infrared detector may be configured to include at least one of aluminum, copper, tungsten, titanium, nickel, chromium, platinum, silver, ruthenium, or cobalt. For example, a material of the reflecting layer 4 may be configured to include at least one of aluminum, copper, tungsten, titanium, nickel, chromium, platinum, silver, ruthenium, or cobalt. In addition, both the CMOS measuring circuit system 1 and the CMOS infrared sensing structure 2 are fabricated using the CMOS process, with the CMOS infrared sensing structure 2 directly fabricated on the CMOS measuring circuit system 1, so that radial side lengths of the columnar structures 6 are greater than or equal to 0.5 μm, less than or equal to 3 μm, and a width of the beam structure 11, (i.e., a width of a single line in the beam structure 11) is less than or equal to 0.3 μm, a height of the resonant cavity is greater than or equal to 1.5 μm, and less than or equal to 2.5 μm, and a side length of a single pixel of the CMOS infrared sensing structure 2 is greater than or equal to 6 μm and less than or equal to 17 μm.

It should be noted that relational terms herein such as “first”, “second”, and the like, are used merely to distinguish one entity or operation from another entity or operation, and do not necessarily require or imply there is any such relationship or order between these entities or operations. Furthermore, the terms “comprising”, “including” or any variations thereof are intended to embrace a non-exclusive inclusion, such that a process, method, article, or device including a plurality of elements includes not only those elements but also includes other elements not expressly listed, or also includes elements inherent to such a process, method, item, or device. In the absence of further limitation, an element defined by the phrase “comprising one . . . ” does not exclude the presence of additional identical elements in the process, method, article, or device.

The above are only specific embodiments of the present disclosure, so that those skilled in the art can understand or realize the present disclosure. Various modifications to these embodiments will be apparent to those skilled in the art, and the generic principles defined herein may be embodied in other embodiments without departing from the spirit or scope of the present disclosure. Therefore, the present disclosure will not to be limited to these embodiments shown herein but is to be in conformity with the widest scope consistent with the principles and novel features disclosed herein.

### INDUSTRIAL APPLICABILITY

The present disclosure is applicable to an infrared detector, realizes the integral preparation of the CMOS measuring circuit system and the CMOS infrared sensing structure on a CMOS production line using the CMOS process, does not have a process compatibility problem, solves the technical difficulty faced by the MEMS process, is simple in preparation process and easy to control, can realize the multi-layer process design of the sacrificial layer, is beneficial to improving the degree of planarization of the film layer, and can realize the target of high yield, low cost, high productivity and large-scale integrated production of the chips, such that the infrared detector has high detection sensitivity, farther detection distance, better detection performances, is more beneficial to the miniaturization of the chip, has good product consistency, and has very strong industrial applicability.

1. An infrared detector based on a CMOS process, comprising:
a CMOS measuring circuit system and a CMOS infrared sensing structure, wherein both the CMOS measuring circuit system and the CMOS infrared sensing structure are fabricated using the CMOS process, and wherein the CMOS infrared sensing structure is directly fabricated on the CMOS measuring circuit system;
wherein the CMOS infrared sensing structure includes at least one sealed release isolation layer above the CMOS measuring circuit system, wherein the sealed release isolation layer is configured to protect the CMOS measuring circuit system from process influence during an etching course for fabricating the CMOS infrared sensing structure;
wherein the CMOS infrared sensing structure comprises at least two metal interconnect layers, at least two dielectric layers and a plurality of interconnect through holes, the dielectric layer comprises at least one sacrificial layer and one thermal-sensitive dielectric layer, wherein the metal interconnect layer comprises at least a reflecting layer and an electrode layer; wherein the thermal-sensitive dielectric layer comprises a thermal-sensitive material with a temperature coefficient of resistance greater than a predetermined value, wherein the thermal-sensitive dielectric layer is configured to convert a temperature change corresponding to infrared radiation absorbed by the thermal-sensitive dielectric layer into a resistance change, and then convert an infrared signal into an electrically readable signal by the CMOS measuring circuit system, wherein the infrared signal corresponds to the resistance change;
wherein the CMOS infrared sensing structure comprises a resonant cavity formed by the reflecting layer and the thermal-sensitive dielectric layer, a suspended micro-bridge structure for controlling heat transfer, and a columnar structure with electrical connection and supporting functions, wherein the CMOS measuring circuit system is configured to measure and process a value of an array resistor formed by one or more CMOS infrared sensing structures and convert the infrared signal corresponding to the value of the array resistor into an image electrical signal.

2. The infrared detector based on the CMOS process according to claim 1, wherein the CMOS infrared sensing structure is fabricated in an upper layer or in the same layer of the metal interconnection layer of the CMOS measuring circuit system.

3. The infrared detector based on the CMOS process according to claim 1, wherein the sacrificial layer is configured to enable the CMOS infrared sensing structure to form a hollow structure, a material of the sacrificial layer is silicon oxide, and wherein the sacrificial layer is etched using a post-CMOS process.

4. The infrared detector based on the CMOS process according to claim 3, wherein the post-CMOS process utilizes at least one of gas phase hydrogen fluoride, carbon tetrafluoride and trifluoromethane to etch the sacrificial layer.

5. The infrared detector based on the CMOS process according to claim 1, wherein the sealed release isolation layer is positioned at an interface between the CMOS measuring circuit system and the CMOS infrared sensing structure or in the CMOS infrared sensing structure, and wherein the sealed release isolation layer is configured to protect the CMOS measuring circuit system from corrosion during the etching process for releasing the sacrificial layer; and
wherein a CMOS process anti-corrosion material used in the sealed release isolation layer comprises at least one of silicon, germanium, silicon-germanium alloy, amorphous silicon, amorphous germanium, amorphous silicon-germanium, amorphous carbon, silicon carbide, aluminum oxide, silicon nitride, or silicon carbonitride.

6. The infrared detector based on the CMOS process according to claim 1, wherein the CMOS infrared sensing structure comprises an absorption plate, a beam structure, the reflecting layer, and the columnar structure;
wherein the absorption plate is configured to absorb the infrared signal and convert the infrared signal into the electrical signal, the absorption plate comprises a metal interconnection layer and at least one thermal-sensitive dielectric layer, and a material of the thermal-sensitive dielectric layer comprises at least one of amorphous silicon, amorphous germanium, amorphous germanium-silicon, titanium oxide, vanadium oxide, or vanadium titanium oxide;
wherein the beam structure and the columnar structure are configured to transmit the electrical signal and configured to support and connect the absorption plate, wherein the beam structure comprises a metal interconnection layer and at least one dielectric layer, and wherein the columnar structure is connected to the CMOS measuring circuit system using the metal interconnection process and the interconnect via process; and
wherein the reflecting layer is configured to reflect the infrared signal and form the resonant cavity with the thermal-sensitive dielectric layer, and wherein the reflecting layer comprises at least one metal interconnection layer.

7. The infrared detector based on the CMOS process according to claim 6, wherein the beam structure is electrically connected to at least two ends of the absorption plate, the CMOS infrared sensing structure comprises at least two columnar structures and at least two support bases, and wherein the electrode layer comprises at least two electrode terminals.

8. The infrared detector based on the CMOS process according to claim 1, wherein the infrared detector is fabricated using 3 nm, 7 nm, 10 nm, 14 nm, 22 nm, 28 nm, 32 nm, 45 nm, 65 nm, 90 nm, 130 nm, 150 nm, 180 nm, 250 nm, or 350 nm CMOS process.

9. The infrared detector based on the CMOS process according to claim 1, wherein a metal wiring material of the metal interconnection layer comprises at least one of aluminum, copper, tungsten, titanium, nickel, chromium, platinum, silver, ruthenium, or cobalt.
